(19) United States
(12) Patent Application Publication
(10) Pub. No.: US 2023/0126202 A1
(43) Pub. Date: Apr. 27, 2023

(54) WEATHER SHIELD FOR AN ENGINE BAY OF A VEHICLE

(71) Applicants: Vincent E Culliver, Pensacola, FL (US); Barbara P Culliver, Pensacola, FL (US)

(72) Inventors: Vincent E Culliver, Pensacola, FL (US); Barbara P Culliver, Pensacola, FL (US)

(21) Appl. No.: 17/971,334

(22) Filed: Oct. 21, 2022

Related U.S. Application Data
(60) Provisional application No. 63/271,450, filed on Oct. 25, 2021.

(51) Int. Cl. B62D 25/12

(52) U.S. Cl. CPC B62D 25/12

(57) ABSTRACT

A weather shield for covering an engine bay of a vehicle, such as a C8 corvette. The weather shield protects the engine and other components in the engine bay from water and sunlight. The shape of the weather shield allows water coming from rain or car wash to channel to drain holes in the engine bay.

### CROSS-REFERENCE TO RELATED APPLICATIONS

This application claims priority from a U.S. Provisional Patent Appl. No. 63/271,450 filed on Oct. 25, 2021, which is incorporated herein by reference in its entirety.

### FIELD OF INVENTION

The present invention relates to a weather shield for an engine bay of a vehicle, and more particularly, the present invention relates to a shield for protecting the engine and other components in an engine bay from rain and sunlight.

### BACKGROUND

A hood, also known as a bonnet, covers an engine bay of a vehicle, such as a car. However, the conventional designs of bonnets provide limited protection against water, sunlight, and the like. Water can easily enter the engine bay over the engine and other components, such as during rain. Similarly, the paint of the vehicle is exposed to direct sunlight resulting in fading of the paint and decreased life. For example, a car model C8 Corvette has an engine on its rear side and air vents are provided through which water can freely enter the engine bay during car wash or rain. Also, the rear window in the C8 Corvette car model allows the sun to shine directly on the engine cover, causing fading of the paint. The excessive heat also deteriorates the rubber hoses, gaskets, seals, etc. thus, repeated exposure to water and sunlight may require frequent repairs which can become quite costly.

A need is therefore appreciated for a weather shield for covering and protecting the engine and other components in an engine bay from dripping water and direct sunlight exposure.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a weather shield for an engine bay.

It is another object of the present invention that the water dripping on the weather shield can be channeled to one or more drains.

It is still another object of the present invention that the weather shield can be rolled for storage.

It is a further object of the present invention that the weather shield can reflect heat to keep the engine bay cooler.

It is yet another object of the present invention that the weather shield can be easily adapted for different vehicles.

A weather shield for covering an engine bay of a vehicle, the weather shield comprises: a support layer; and reflective layers forming an outer surface of the weather shield, wherein the support layer is flexible enough to permit folding of the weather shield and rigid enough so that the weather shield maintains its shape in an unfolded state, wherein the weather shield is dimensioned to cover the engine bay just below the hood of the vehicle. The weather shield has slots for accommodating hinge joints of the hood. The weather shield according to claim 1, wherein the weather shield is dimensioned to be supported on an opening periphery flange of the engine bay.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a weather shield, according to an exemplary embodiment of the present invention.

FIG. 2 is a top view of the weather shield, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is a weather shield for vehicles to protect the engine and other components including electrical components in the engine bay from exposure to water and sunlight. The disclosed weather shield can protect the paint on the engine from sunlight exposure.

The disclosed weather shield can be adapted for different vehicles. For example, the weather shield can be designed for the C8 Corvette car model, wherein the weather shield can cover the engine bay to prevent the entry of water or exposure to sunlight through the window of the C8 Corvette.

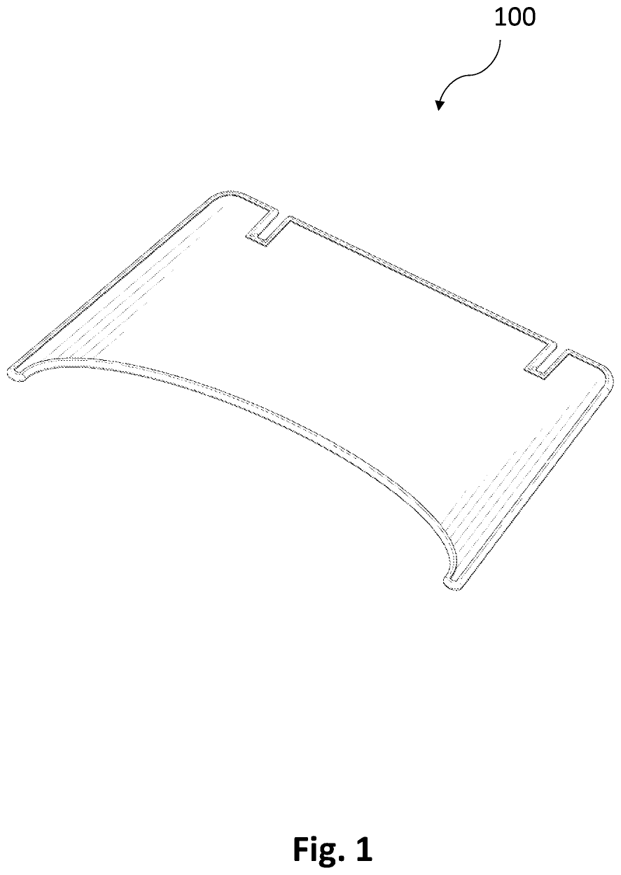

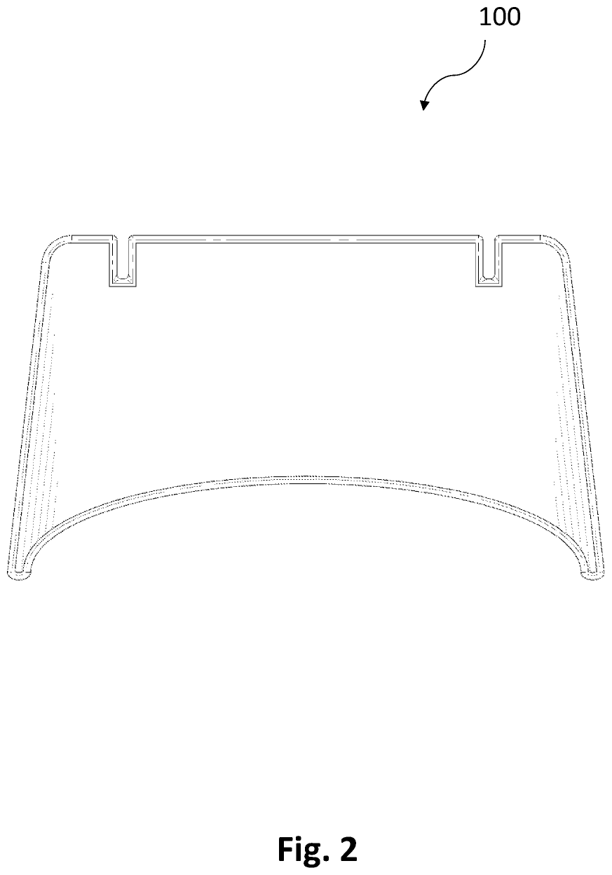

Referring to FIGS. 1 and 2 which show different views of a weather shield adapted for the C8 Corvette car. The weather shield is shaped to completely cover the engine bay such that water cannot enter either during rain or a car wash. The water falling/dripping on the mounted weather shield can be channeled to drail holes in the engine bay, thus water does not collect over the weather shield. For example, the weather shield can be supported on an opening peripheral flange of the engine bay. Both sides of the weather shield can be provided with a layer of reflective material, such as silver or aluminum. The reflective material of the weather shield can reflect sunlight preventing heat buildup in the engine bay. Moreover, the engine surface is no longer exposed to sunlight.

When not in use, the disclosed weather shield can be folded and stored in a suitable place inside the car. The folded weather shield can be unrolled and placed over the engine bay when required. The weather shield can be made from any durable material that is flexible but can retain shape in the sheet form. The weather shield can have multiple layers, such as outer reflective layers, insulative foam layers, and a plastic layer for support and maintaining shape.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A weather shield for covering an engine bay of a vehicle, the weather shield comprises:
a support layer; and
reflective layers forming an outer surface of the weather shield, wherein the support layer is flexible enough to permit folding of the weather shield and rigid enough so that the weather shield maintains its shape in an unfolded state,
wherein the weather shield is dimensioned to cover the engine bay just below the hood of the vehicle.

2. The weather shield according to claim 1, wherein the weather shield has slots for accommodating hinge joints of the hood.

3. The weather shield according to claim 1, wherein the weather shield is dimensioned to be supported on an opening periphery flange of the engine bay.
